(19) United States
(12) Patent Application Publication
(10) Pub. No.: US 2023/0337215 A1
(43) Pub. Date: Oct. 19, 2023

(54) Radio Access Network (RAN) Slice Scheduler Methods and Apparatus

(71) Applicant: Celona, Inc., Campbell, CA (US)

(72) Inventors: Srinivasan Balasubramanian, San Diego, CA (US); Mehmet Yavuz, Palo Alto, CA (US); Kuldeep Singh, Campbell, CA (US)

(21) Appl. No.: 18/301,095

(22) Filed: Apr. 14, 2023

Related U.S. Application Data
(60) Provisional application No. 63/331,155, filed on Apr. 14, 2022.

(51) Int. Cl. H04W 72/12

(52) U.S. Cl. CPC H04W 72/12

(57) ABSTRACT

A Radio Access Network (RAN) Slice Scheduler methods and apparatus allowing shared resources from an Enterprise Network deployment to be managed across Mobile Network Operators (MNOs) and private Enterprise users is disclosed. Rebalancing of resource allocations provided to each MNO in the APs on a site is based on the population of User Equipment (UEs) and traffic experienced in accordance with the disclosed methods and apparatus.

### INCORPORATION BY REFERENCE

This non-provisional application claims priority to an earlier-filed provisional application No. 63/331,155 filed Apr. 14, 2022, entitled “Radio Access Network (RAN) Slice Scheduler Methods and Apparatus” (ATTY DOCKET NO. CEL-065-PROV) and the provisional application No. 63/331,155 filed Apr. 14, 2022, and all its contents, are hereby incorporated by reference herein as if set forth in full.

### BACKGROUND

### (1) Technical Field

The disclosed methods and apparatus relate generally to wireless communication networks, and in particular, the disclosed methods and apparatus relate to RAN Slice Scheduler methods and apparatus allowing shared resources from an Enterprise Network deployment to be managed across Mobile Network Operators (MNOs) and private Enterprise users. Rebalancing of resource allocations provided to each MNO in the APs on a site is based on the population of User Equipment (UEs) and traffic experienced.

### (2) Background

The wireless industry has experienced tremendous growth in recent years. Wireless technology is rapidly improving, and faster and more numerous broadband communication networks have been installed around the globe. These networks have now become key components of a worldwide communication system that connects people and businesses at speeds and on a scale unimaginable just a couple of decades ago. The rapid growth of wireless communication is a result of increasing demand for more bandwidth and services. This rapid growth is in many ways supported by standards. For example, 4G LTE has been widely deployed over the past years, and the next generation system, 5G NR (New Radio) is now being deployed. In these wireless systems, multiple mobile devices are served voice services, data services, and many other services over wireless connections so they may remain mobile while still connected.

It is commonplace today for communications to occur over a wireless network in which user equipment (UE) connects to the network via a wireless transceiver, such an eNodeB, gNodeB, access point or base station, hereafter referred to generically as a BS/AP (base station/Access Point). In this disclosure the term eNodeB is shortened to the term “eNB” or “gNB” and is used generically to refer to the following: a single sector eNB/gNB; a dual sector eNB/gNB, with each sector acting independently; and a node that supports both eNB and gNB functions. The UE may be a wireless cellular telephone, tablet, computer, Internet-of-Things (IoT) device, or other such wireless equipment. The BS/AP may be an eNodeB (“eNB”) as defined in 3GPP specifications for long term evolution (LTE) systems (sometimes referred to as 4th Generation (4G) systems) or a gNodeB as defined in 3GPP specifications for new radio (NR) systems (sometimes referred to as 5G systems). Furthermore, the BS/AP may be a single sector node or a dual sector node in which each of two sectors act independently. In 4G and 5G systems, there are times when a relatively large number of UEs may be attempting to access the network through the same “cell”.

In many cases, there is a mix of UEs, some requiring high throughput with data arriving in bursts and other UEs requiring minimal throughput, but having frequent data transmit and receive requirements. The term ‘BS/AP” is used broadly herein to include base stations and access points, including at least an evolved NodeB (eNB) of an LTE network or gNodeB (gNB) of a 5G network, a cellular base station (BS), a Citizens Broadband Radio Service Device (CBSD) (which may be an LTE or 5G device), a Wi-Fi access node, a Local Area Network (LAN) access point, a Wide Area Network (WAN) access point, and should also be understood to include other network receiving hubs that provide access to a network of a plurality of wireless transceivers within range of the BS/AP. Typically, the BS/APs are used as transceiver hubs, whereas the UEs are used for point-to-point communication and are not used as hubs. Therefore, the BS/APs transmit at a relatively higher power than the UEs.

FIG. 1 is an illustration of components of a wireless communications network 100. In some embodiments, the wireless communications network 100 comprises a Radio Access Network (RAN). It is commonplace today for communications to occur over a wireless network in which user equipment (UE) (such as, for example, UEs 101a, 101b, 101c, and 101d) connect to the network via a wireless transceiver, such an eNodeB (eNB), gNodeB (gNB), Access Point (or base station) 103, hereafter referred to generically as a BS/AP (base station/Access Point) or more simply, an Access Point (AP) 103. A wireless device operated by a user, commonly referred to as a “User Equipment” (UE), is typically in wireless communication with the Access Point (AP) 103, or, more specifically, via a base station antenna 109. Although only a single AP 103 is shown in FIG. 1, several APs 103 are used to communicate with a plurality of UEs in typical communication network 100 deployments.

As shown in FIG. 1, the BS/AP 103 (or a plurality of BS/APs 103 which are not shown in FIG. 1 for simplicity's sake) communicate with an Edge Node 120. The Edge Node 120 communicates with the other components of the RAN 100 and the RAN Core Network 114, and allows users of the various UEs 101 access to services provided by the RAN 100 including those provided by the Internet 107. In some embodiments, the RAN Core Network 114 comprises a 5G Core Network (5GC).

FIG. 2 is a diagram of a wireless communication network that may be implemented as an Enterprise Network 200 using a CBRS network. A plurality of BS/APs 202a, 202b, 202c, and 202d are deployed in an enterprise location 200. It should be noted that throughout this disclosure, a reference string (such as “202a”) used to identify a feature in a figure, having a string of numeric characters followed by one or more alphabetic characters, identifies a feature of the figure that is similar to other features in the figures having the same numeric string of characters. For example, the BS/AP 202a is similar in terms of functionality and performance to the BS/AP 202b, 202c and 202d. Furthermore, a reference string having only the numeric string (i.e., lacking the alphabetic characters) refers collectively to all of the features having the same numeric string. For example, the BS/AP 202 refers collectively to all four of the BS/APs 202a, 202b, 202c and 202d.

In FIG. 2, each BS/AP 202 has a range, defining a wireless coverage area or “Radio Footprint”. The BS/APs 202 may comprise CBSDs in a CBRS system. A first UE 201a is wirelessly connected to a first BS/AP 202a, which is providing service to it. A second UE 201b is wirelessly connected to a second BS/AP 202b, and is providing service to the second UE 201b. Other UEs 201, which connect wirelessly to the BS/APs 202, are shown in the enterprise location 200. All of the BS/APs 202 are connected to a PDN 220 by any appropriate communication means, such as wire, fiber optic, and wireless radio. The PDN 220 provides a connection to an operator network 222 that includes an Oracle (OAM) Server 207, a SON assist unit 208, a Domain Proxy 209, an Automatic Configuration Server (ACS) 210 and a Location Database 211, all of which are connected to each other within the operator network 222 by any appropriate communication means. An MNO network may be connected to a Spectrum Access System (SAS) 212, which is connected to a Spectrum Database 213 that includes data regarding the CBRS spectrum that the SAS 212 manages. Collectively, the SAS 212 and the Spectrum Database 213 are referred to as a Spectrum Management Entity (SME) 214. As is well known, the SAS 212 is typically a cloud-based service that manages the wireless communications of devices transmitting in the CBRS band, in order to prevent harmful interference to higher priority CBRS users. A CBRS device (CBSD) needs authorization from the SAS 212 before it begins transmissions in the CBRS band.

In some of the literature, the BS/APs 202 within a CBRS network are termed “CBSDs”, and the UEs 201 are termed End User Devices (EUDs). CBSDs are fixed Stations, or networks of such stations, that operate on a Priority Access License (PAL) or General Authorized Access (or sometimes referred to as “General Availability Access”) (GAA) basis within the CBRS band consistent with Title 47 CFR Part 96 of the United States Code of Federal Regulations (CFR) (hereafter “Part 96” or “the Part 96 rules”). Title 47 CFR Part 96 of the United States Code of Federal Regulations (CFR) (or Part 96) is hereby incorporated by reference herein as if set forth in its entirety. PALs must protect and accept interference from Incumbent Access users (higher tier users) but receive protection from General Authorized Access users (lower tier uses).

The CBRS rules require that a SAS (such as the SAS 212 of FIG. 2) allocate spectrum to the CBSDs to avoid interference within the CBRS band. The SAS 212 is a service that manages the spectrum used in wireless communications of devices transmitting in the CBRS band in order to prevent harmful interference to higher priority users such as the military and priority licensees. As noted above, a CBRS device, such as a CBSD, needs authorization from the SAS 212 before beginning to transmit in the CBRS band. Even after receiving authorization to transmit in the CBRS band, the SAS 212 may suspend or terminate authorization of one or more of the channels previously authorized by it.

FIG. 3 shows a configuration in which a UE within the radio coverage area (RF footprint) of an MNO network can communicate with the MNO network and an Enterprise Network through an MNO BS/AP (i.e., through either an eNB or gNB). Some enterprise networks 305 provide a communication service that allows their subscribers to establish a communication link to the enterprise network's infrastructure (e.g., an enterprise core network 306, such as an enterprise EPC) through the physical radio infrastructure of another network (e.g., the MNO 303). An architecture in which more than one core network (hereafter “core”) 306, 307 can be accessed through the same BS/AP is commonly referred to as a Multi-Operator Core (MOCN). In some embodiments, the BS/AP is an eNB (Evolved Node B or alternatively E-UTRAN Node B) 304. In such cases, a gateway, such as a MOCN gateway 309, resides between the eNB 304 and one or more cores, each of which can be accessed by a UE 302 through the eNB 304. The MOCN gateway directs packets that flow from the UE 302 through the eNB 304 to the appropriate core 306 (for example, the EPC core 306). While only one such core 306 is shown, it should be understood that there may be other such cores as well. An enterprise network subscriber UE (hereafter, simply referred to as a “TP UE”) 302 within the coverage area of an MNO network 303 may be connected to the MNO eNB 304. The MNO eNB 304 is part of the MNO network 303; but is connected to the enterprise network 305 through the MOCN gateway 309. Accordingly, the MNO eNB 304 can be used to connect the UE 302 to the enterprise network's EPC 306.

Current and future mobile networks such as those shown in FIGS. 1 and 2, and others, must accommodate a variety of services each having different network requirements. RAN network slicing and scheduling of same is an important aspect of the RAN in coping with the increasing complexity of such wireless networks. Therefore, a need exists for a RAN slicing scheduler methods and apparatus that satisfies network requirements, including but not limited to MNO SLO/SLA (Service Level Agreements) requirements established by agreements, QoS guarantees provided to the MNOs for UEs that camp on Enterprise Networks, and a variety of other factors.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 shows an illustration of components of a wireless communications network.

FIG. 2 is a diagram of a wireless communication network that may be implemented as an Enterprise Network 250 using a CBRS network.

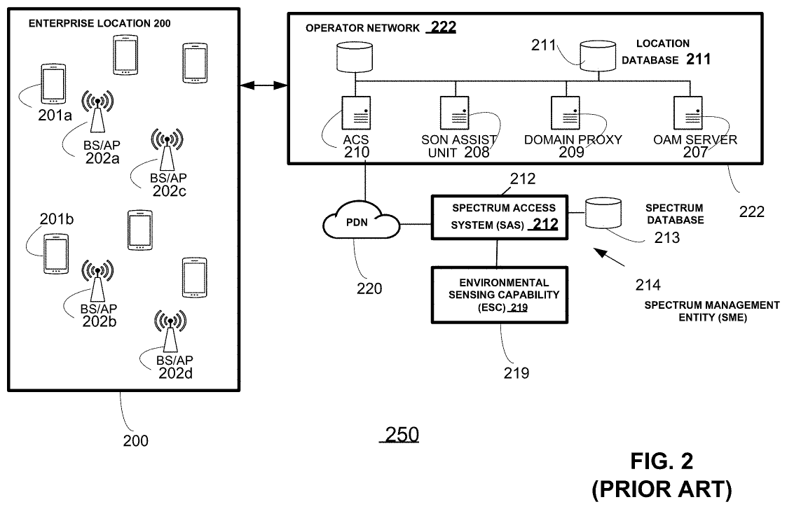

FIG. 3 shows a configuration in which a UE within the coverage area of an MNO network can communicate with the MNO network and the Enterprise Network through an MNO BS/AP.

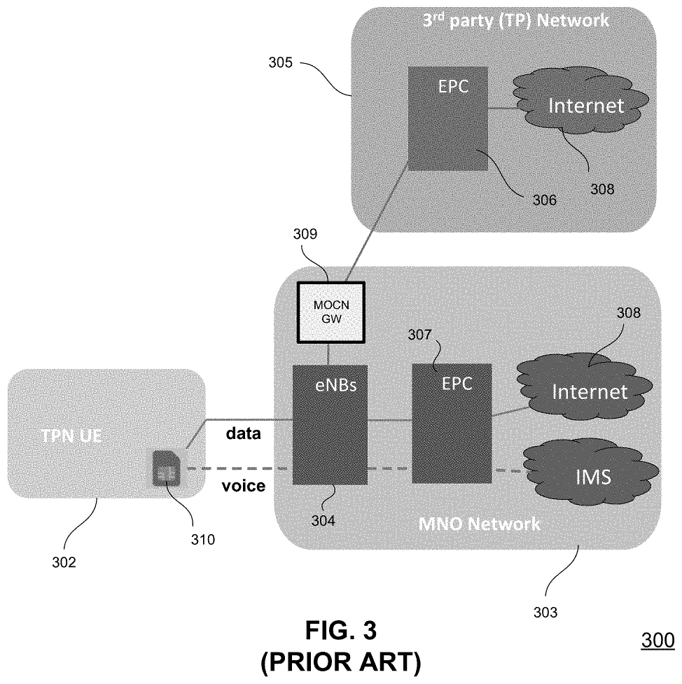

FIG. 4 shows a block diagram of one example of deployments of a RAN network and showing various possible physical placements of the RU, DU and CU functionality throughout the RAN network.

FIG. 5 shows a diagram of a “Token Bucket” for RAN Slice PRB management in accordance with the present RAN slice scheduler methods and apparatus.

FIG. 6 shows a plot of a Sigmoid Function Mapping to Scheduler Metric.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

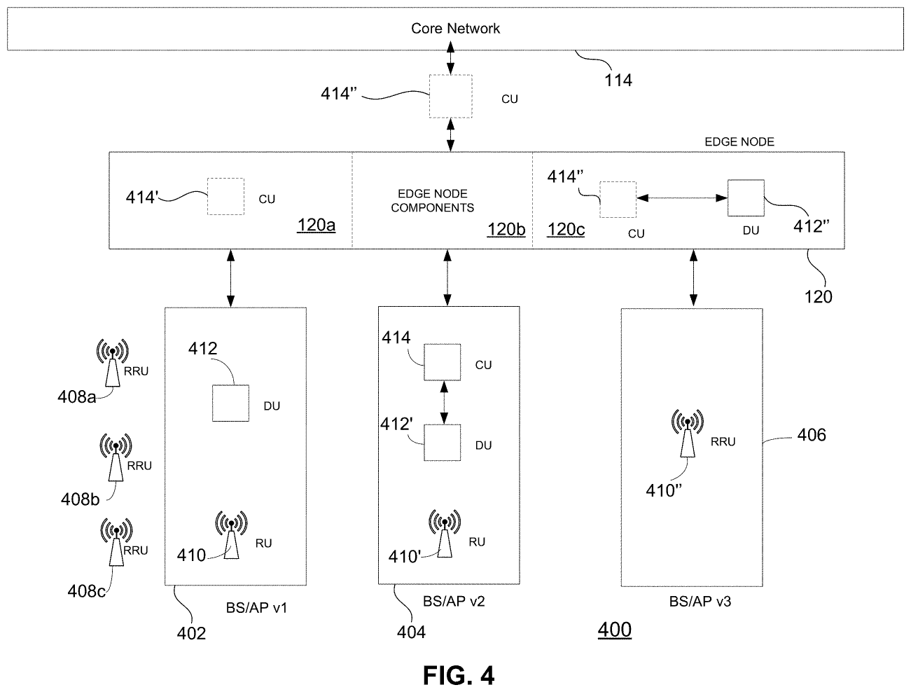

FIG. 4 shows a block diagram of one example of deployments of a RAN network and showing various possible physical placements of the RU, DU and CU functionality throughout the RAN network. The RAN network of FIG. 4 is for explanatory purposes only and should not be interpreted as actual (“real world”) RAN deployments. As shown in FIG. 4, three different versions of BS/APs (BS/AP v1 402, BS/AP v2 404 and BS/AP v3 406) are shown at the bottom of the figure. As shown in FIG. 4, the AP can be deployed as a monolithic “all-in-one” unit deployed at a cell site, as in classic cellular networks, such as in the BS/AP v2 404 of FIG. 4. As shown, the BS/AP v2 404 co-locates the RU 410′ with the DU 412′ and the CU 414. Alternatively, the CU, DU and RU can be split away from being implemented as a monolithic “all-in-one” cell site as shown in the B S/AP v1 402 and B S/AP v3 406. B S/AP v1 402 includes the RU 410 co-located with the DU 412, whereas the BS/AP v3 406 includes only a Remote RU (RRU) 410″, so named because it is located at a distance (remote) from the DU. Other RRUs (408a, 408b, and 408c) are also shown in the RAN 400 of FIG. 4, and these RRUs 408 also communicate with the DU 412.

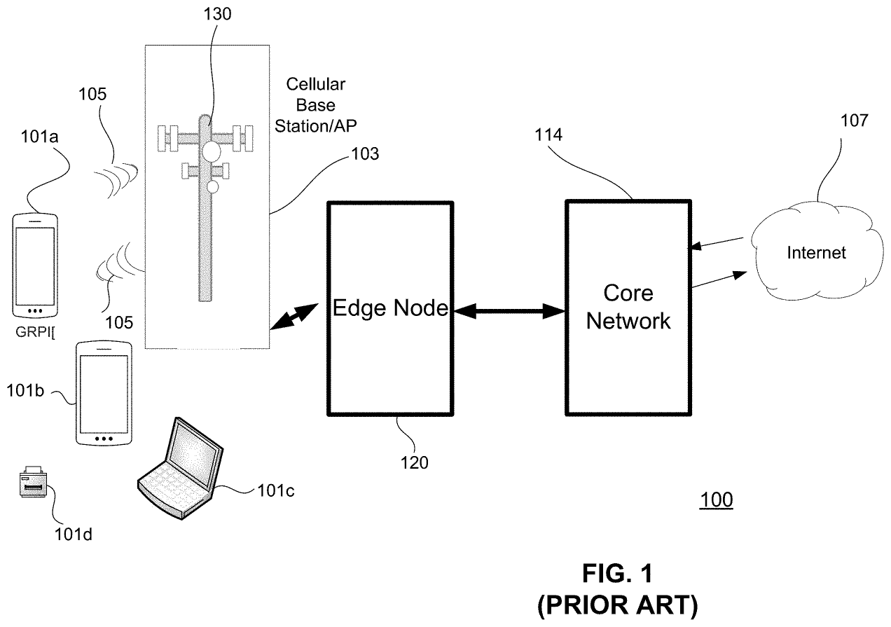

As shown in FIG. 4, all of the APs 402, 404 and 406 communicate with the Edge Node 120 (as is also shown in FIG. 1). Depending on the type of AP, and more specifically, depending on whether the AP 402, 404 or 406, includes a DU or CU, the AP communicates with either a DU that is off-loaded to the Edge Node 120 or a CU located somewhere within the RAN 400. For example, the AP v1 402 DU 412 communicates with the CU 414′ located in the Edge Node 120a. The AP v3 406 communicates with the DU 412″ and the CU 414″ located in the Edge Node 120c. The RAN 400 of FIG. 4 also demonstrates that the CU can be implemented and deployed in different nodes and locations within the RAN 200 as shown in FIG. 4. For example, the CU 414 is located within a monolithic, integrated, and centrally located AP 404. However, the CU can optionally be offloaded and located in the Edge Node 120 (such as the CU 414′ in the Edge Node 120a, or the CU 414″ and DU 412″ combination located in the Edge Node 120c). Alternatively, the CU 414′″ can be located between the Edge Node 120 and the RAN Core Network 114. So, as can be seen, the CU and DU can be co-located with the RU or physically distanced therefrom in some embodiments.

Problem or Enhancement Addressed by the present methods and apparatus:

MNOs are provided SLOs/SLAs which are seen as capacity allocations and QoS guarantees provided to the MNO UEs that camp on the enterprise network.

High Level Requirement
Immediate requirement
   Allow for clear representation of how the shared resources from an enterprise deployment will be managed across MNOs and private enterprise users.
Mid-term requirement
   Enterprise network that is managed by a specific MNO.
Longer term possible requirement
   An MNO signs up for Neutral Host connectivity support with an enterprise campus, it also makes available the PAL that the MNO has purchase to be available for the enterprise campus use.
   It is possible for multiple MNOs to have neutral host agreements with a given enterprise campus, each providing its PAL spectrum for use within the enterprise campus.
   The expectation from one MNO (VzW) was to allow the use of the PAL spectrum only for VzW users on the campus.
   Isolating PAL spectrum to the associated MNOs.
This is not a viable option given that each CBSD will likely have both PAL and GAA spectrum used for its operation.
Hardware deployment for a neutral host cannot be isolated only to a specific MNO given that a specific coverage on campus may not have users from that MNO.
It also is possible for users of an MNO to be clustered in a certain coverage area, while other areas on campus don't have any users for that MNO.
Dedicating PAL spectrum to a specific MNO will also require dedicating HW and will have to cover the full campus for each MNO.

Open Issues
MNO reporting interval.
Providing minimum bitrate guarantees.
MNO specific underperformance (on a cell or across the full network) In some embodiments, all UEs are treated independent of MNOs equally when the UEs are camped on the enterprise network.

Description with Technical Advantages or Benefits

RAN Slice and Core Network Slice
RAN level slices as PRB s are determined and specified for each eNB/gNB
   Applied as an instantaneous metric on a slot-by-slot basis and handled as use-it-or-lose-it basis.
   Address changing TDD configurations based on time-of-day and predicted DL and UL traffic.
Core level slices are managed as allowed peak bitrates
   For neutral host, all traffic will flow through the MOCN GW and into the MNO core. However, it is possible that Local-Traffic-Offload (LTO) to allow access to the enterprise core may be supported.
The PRB allocation at the RAN is proportionally allocated based on the weights of the enterprise, and the different MNO-x entities.

Assumptions
It is better to provide SLA agreements that are aggregated across the enterprise campus to manage capacity allocations to a given MNO

Admission Control
Admission control for idle system camping needs to be regulated based on proportional capacity allocation requirement for a given MNO
Currently admission control only regulates the capacity allocation for GBR bearers.

Admission Control—Absolute MNO Capacity Limit
Limit the GBR flow admission only up to the capacity allocated to the MNO.

Admission Control—Adaptive MNO Capacity Limit
Admission control when the GBR bearer allows for pre-emption
   Flows are admitted if there is AP capacity available, subject to the clause below.
Admission control when the GBR bearer does not allow for pre-emption
   Flows are admitted only when the capacity occupied by the non-preemptable flows is below capacity assigned to the MNO capacity and the current flow being admitted.
      Option 1: has a higher priority than the preemptable flows for any MNO.
      Option 2: independent of the priority of the preemptable flows for an MNO that is occupying more than its allocated capacity.
   Otherwise, this flow is not admitted into the system.
The GBR traffic is admitted for a given MNO that is going above its allocated capacity only when the overall cell capacity is below 60%. Note that the UEs are admitted to system only up to 80% allowing room for UEs mobility across cells and retaining some capacity for AMBR traffic.

Congestion Control
The QoS requirements for GBR bearers are handled based on the needs of the individual flows.
   The handling of the additional throughput to scale up to MBR rates will scale proportionally to the capacity allocated to the MNO.
   The GBR allocated to the flow will also be subject to allocated capacity to the MNO and managed during admission control. It is possible that a flow does not get admitted and a service is blocked for the user or is admitted with a subdued GBR.
For the nonGBR bearers, the throughput is managed through proportional capacity allocation; Minimum throughput guarantees are required.
Under heavy congestion, the UEs need to be redirected to the macro frequency knowing the available coverage from a given AP associated with each MNO.
   Emergency; WPS calling support will take higher priority

Preemption Control
Preemption is handled based on the proportional resource allocation for each MNO.
   No preemption is done until the resource limits of a given cell is reached. This is dependent of the capacity allocated to a given MNO and the amount utilized by that MNO UEs.
   An ordering of priority for users and services within each MNO is maintained for preemption when the limits are reached. If arbitration is required amongst equal priority users, a random user is selected for preemption.
   MNO users are allowed to utilize any available capacity from the cell. Only when the enterprise user or other MNO users require the capacity based on the capacity partitioning, the MNO usage beyond the allocated capacity is determined to require preemption.
The proportionality is handled based on the bearer type, the PAL allocations provided for in-campus operations, or other based on specific business arrangements between the MNO and enterprise, and the population of the UEs (individual MNOs and enterprise UE) subject to the peak support agreement established with the campus.

Preemption Control—Absolute MNO Capacity Limit
If there are not enough resource to admit incoming GBR bearer of MNO-x, only the bearer of MNO-x UEs are considered for preemption.

Preemption Control—Adaptive MNO Capacity Limit
If there are not enough resource to admit incoming GBR bearer of a given MNO and MNO is using more than allocated capacity, no preemption is triggered to admit new bearer.
If there are not enough resource to admit incoming GBR bearer of a given MNO when MNO is using less than allocated capacity, we try to free the resources by pre-empting existing bearer. Candidate selection criteria for pre-emption candidate is mentioned below.
   Bearer of other MNOs using less than allocated capacity are not selected for pre-emption.
   Bearer on MNOs using more than allocated capacity are selected first based on ARP values.
   New Bearer of MNO using less than allocated capacity could preempt bearer of MNO using more than allocated capacity even if priority of incoming bearer is lower than candidate.

Static Partition with One Pass Scheduling—an Example of a Solution
The resource allocation for the individual MNOs and the enterprise devices are provisioned in the eNB/Gnb.
The paging and access capacity is shared across all MNOs and enterprise UEs.

1A.1—The following is one example of a procedure in accordance with the disclosed method and apparatus.

The resources will be statically allocated across all eNB/gNB independent of the constitution of the UEs in the cell. The value is specified in units of PRBs for a Refresh interval time period−DL-PRB_{Allocated-MNO-x} and UL-PRB_{Allocated-MNO-x}. The available PRBs is identified as a % of the total capacity of the AP and the PRBs available to an MNO on an AP is determined based on the BW allocated to the AP by the SON algorithm.

Any left-over capacity is allocated to enterprise devices—UL-PRB_{Enterprise} and DL-PRB_{Enterprise}. Enterprise is treated like another MNO from this point.

Token Bucket Definition

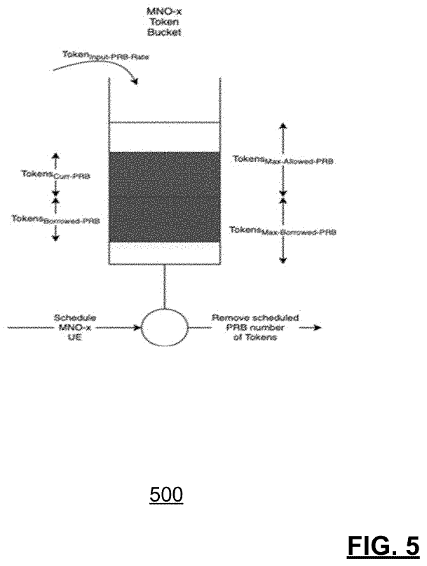

FIG. 5 shows a diagram of a “Token Bucket” 500 for RAN Slice PRB management in accordance with the present RAN slice scheduler methods and apparatus. As shown in FIG. 5:
Token_{Input-PRB-Rate}: Tokens are refreshed at a rate proportional to the RAN slice capacity allocation. The token refresh rate can be done every slot or at periodic interval, potentially even once every Refresh Interval. It is derived from DL-PRB_{Allocated-MNO-x} and UL-PRB_{Allocated-MNO-x} and adjusted to the T_{TokenRefresh}, the token refresh timeperiod.
   DL-Token_{Input-PRB-Rate}=DL-PRB_{Allocated-MNO-x}*T_{TokenRefresh}/SCH_CMN_REFRESH_TIME.
   UL-Token_{Input-PRB-Rate}=UL-PRB_{Allocated-MNO-x}*T_{TokenRefresh}/SCH_CMN_REFRESH_TIME.
Token_{Curr-PRB}: Indicates the current number of tokens in the bucket.
Token_{Borrowed-PRB}: These are tokens borrowed for scheduling a given MNO's UEs more than the available tokens in the bucket. As tokens are replenished, the value is decremented until it reached 0. Any further token added is accumulated in the Token_{Curr-PRB}.
Token_{Max-Borrowed-}PRB: To prevent penalizing an MNO of borrowing tokens based on it usage, which is based on lack of traffic from other MNOs, the tokens borrowed in the bucket is capped at a certain level.
   Defaulted to tokens for up to 1 Refresh Intervals.
   This value determines the extent of starvation that can be caused for a given MNO.
Token_{Max-Allowed-PRB}: To prevent over allocations of tokens to a given MNO, the tokens allowed in the bucket is capped at a certain level.
   Defaulted to tokens for up to 1 Refresh Intervals.
   This value determines the extent of starvation that can be caused to the other MNOs.

It should be noted that all of the above parameters may be provisioned on an MNO basis.

RAN Slice Scheduling Procedure
UEs are selected for scheduling per the existing prioritization.
The contResLst, HARQ retransmissions, sigLst SRB+SR Request, and gbrLst are handling with the existing procedures.
   The token from the MNO-x bucket is removed based on the PRBs used to UEs served.
If there are UEs from different MNOs that have GBR traffic, UEs associated with MNO-x is selected based on the MNO-x that has the largest number of tokens.
   This is done to ensure that when the MBR/AMBR traffic is scheduled, the UEs selected have sufficient tokens to be scheduled and hence providing fairness across MNOs for scheduling traffic.
   It is possible for different MNOs to have different RAN capacity allocations and under such scenarios, an inverse proportionality is applied to the number of available tokens used for comparison.
To avoid the scenario of UEs with GBR traffic occupying all of the channel due to the limited number of UEs per slot that can be scheduled:
   When a given MNO UEs have only AMBR traffic, the number of UEs with GBR traffic is limited (below 4, which is the max number of UEs supported now) to accommodate such UEs with AMBR traffic.
   Based on the occupancy of the MNO UE with AMBR traffic relative to the MNO allocated capacity, the UEs with GBR traffic for the other MNOs are limited to accommodate UEs of an MNO that has only AMBR traffic.
   Note that his approach will be required only when starvation of AMBR traffic is seen for specific MNO. Also, this can be performed only when the delay bounds for the GBR traffic can be met. Otherwise, flows need to be preempted based on the capacity needs of the different MNOs.

Additionally, for the mbrLst and AmbrLst the below steps are followed.

MBR and AMBR Scheduling Based on Absolute MNO Capacity Limit
An MNO-UE is scheduled for MBR/AMBR traffic only when Token_{Curr-PRB}>0 for that MNO.
If there are UEs from different MNOs that have MBR/AMBR traffic, UEs associated with MNO-x is selected based on the MNO-x that has the proportionally largest number of tokens.
The capacity occupied by the MNO UEs is limited to the allocated capacity for that MNO. When there are no more token available for that MNO, no further traffic is processed for that MNO.
   This could imply that the cell capacity can be wasted.

MBR and AMBR Scheduling Based on Adaptive MNO Capacity Limit
An MNO-UE is scheduled for MBR/AMBR traffic even when Token_{Curr-PRB}<0 for that MNO.
When for scheduling MBR and AMBR traffic, MNOs that have proportionally more token are prioritized above the other MNOs.
   Given that all MBR traffic is scheduled before AMBR, the check for selecting UEs to schedule MBR and AMBR traffic is done together identifying the MBR and AMBR flows that will be processed.
   The MNOs UEs that have proportionally higher number of token are prioritize over other MNO UEs independent of whether the flows belong to MBR or AMBR traffic.
This will implicitly address the scenario when there are lot more UEs from a given MNO that require GBR support and another MNO that has only AMBR traffic.
When there are no other UEs that have traffic, the UEs that have traffic is chosen including the UE that belong to MNOs that have Token_{Curr-PRB}<0.
When there are not enough tokens, tokens are borrowed to allow the UE to be scheduled.
   Borrowing is allowed even when Token_{Borrowed-PRB}=Token_{Max-Borrowed-PRB}.
   This is used to accommodate the limitations of the number of UEs that can be scheduled in a slot and also to address the scenario when other MNOs may not have enough traffic that needs to be scheduled.

1A.2—The following is a second example of a procedure in accordance with the presently disclosed method and apparatus.

The procedure remains the same 1A.1 with the added function of rebalancing the of the resource allocations across the APs for each MNO. Treated as aggregate campus-wide resource allocation for a given MNO.

The aggregate campus-wide capacity is determined based on the sum of capacity allocated to the individual APs in terms of PRBs. Note that this capacity adapts based on the changes to the APs and the BW allocations to the individual APs as determined by the SON algorithm.

The capacity allocated to each MNO is determined by the below procedure. Any rebalancing of resources across the APs maintains this total capacity allocation for each MNO.

$${TotalCapacity}_{MNOx} = {\sum }_{A P s} {PRB}_{AP} * {Percentage}_{MONx}$$

AP's Request for Rebalancing of Resource Allocations

Each AP determines if rebalancing of resources is needed. This is determined by looking at the offered load and comparing it with the capacity allocated to each MNO. All reports are sent to a central entity MNO-Capacity-Rebalancer (MCR).
If (OfferedLoadMNO-x<80% CapacityMNO-x), then it is it sends a notification to MCR indicating the capacity the AP willing to relinquish for that MNO-x.
If (80% CapacityMNO-x<OfferedLoadMNO-x<120% CapacityMNO-x), then it is it sends a notification to MCR indicating that it has optimal capacity allocation for MNO-x.
If (OfferedLoadMNO-x>120% CapacityMNO-x), then it is it sends a notification to MCR indicating the capacity the AP is wanting increased allocation for MNO-x.

The capacity requests from AP to MCR are either sent as a % of the AP capacity or it is sent in terms of the PRBs.

MCR Operations

The MCR looks at the input received from each AP and sees if the resources can and need to be mover from one to another based on the requests received. Finding the combination that allows for optimal use of the network capacity while retaining the overall capacity allocation for each MNO for the site as a whole is ensured. The capacity is rebalanced as % of the AP capacity or it is sent in terms of the PRBs.

The APs available rebalancing of resources is determined based on the below conditions. The resource allocation include BW allocation to each AP and also the amount of resources allocated to each MNO within each AP.
When an AP request for less capacity for all MNOs, then the AP is a candidate for BW reduction.
An AP is a candidate for rebalancing only when the request from that AP includes an MNO that request for more resources and another MNO from the same AP that request for reduction in the capacity allocation.
When the request from the AP is all MNO either requiring to retain the current capacity allocation or a requiring more resource allocation then rebalancing with the current BW allocation will not be possible. Such APs are candidate for BW expansion.

In a form with only one MNO, which can just be the enterprise users alone, this reduces to a trigger from CBSD requesting for BW change in allocation. It can be to increase or willing to support a reduced BW. This information can be used in a central manner as part of the SON algorithm to allow rebalancing the BW allocations including ways to support freq-reuse-of-one along with PRB usage separation across the APs.

Example of a Solution 1B: Static Partition with Two Pass Scheduling
The resource allocation for the individual MNOs and the enterprise devices is provisioned in the eNB/gNB

Example of a Solution 1B.1
The resources will be statically allocated across all eNB/gNB independent of the constitution of the UEs in the cell
The scheduler will go through the individual MNO UEs and utilize the capacity allocated to that MNO
Enterprise is treated similar to an MNO in terms of resource allocation
A second pass is made redistributing the unused capacity from the individual MNOs/Enterprise resource allocations to other UEs. Fairness for handling the remaining capacity by distributing it in a round-robin manner.

Example of a Solution 1B.2
Example of a Solution 1B.1 with the additional feature of rebalancing the allocations to the individual MNOs as suggested in 1A.2.

Example of a Solution 2: Support a Weighted-Fair-Share Scheduler

Example of a Solution 2: Weights Determination
Weights are determined statically and provided to the RAN scheduler for each UE
   W_{Enterprise}=1
      Is the weight that applies to a UE operating with an enterprise subscription
   W_{MNO-x}=1+[NumberOfPALChannels_{MNO-x}/15], where NumberOfPALChannels_{MNO-x} is the number of PAL channels provided by MNO for enterprise level operation
      Is the weight that applies to a UE operating with MNO-x subscription
      It is computed for each MNO that support a neutral host on the enterprise campus

Example of a Solution 2: Application of the Weights
Admission control
   To prioritize admitting UE into the system
   To admit specific flows for a given UE into the system
   To determine the allowed GBR and MBR value for a given GBR bearer
   To specific the nonGBR QCI value
      QCI=9,8,7,6; where the priority levels are applied as QCI=6>QCI=7>QCI=8>QCI=9

Congestion Control
For a GBR bearer, the scaling of the traffic above GBR bitrate up to MBR bitrate is proportionally adjusted based on the weights of the individual flows;
Handling nonGBR bearers
   Approach 1: For nonGBR bearer, the scheduling algorithm (e.g., proportional-fair) is further biased by the weight associated with the flow
   Approach 2: The nonGBR bearers are associated with specific QCI values from 6 to 9. The weights for these QCIs are assigned based on the weight determine for enterprise and MNO-x per the logic described earlier

Preemption
Preempting of GBR bearers/UE is further biased based on the weights associated with the UE

RAN Slice Scheduler Metrics
The scheduler metrics are aggregated and reset every Refresh Interval.
The capacity in terms of the PRBs allocated to the individual UEs is collected within the Refresh Interval—DL-PRB_{MNO-x-UE} and UL-PRB_{MNO-x-UE}. This counter is also reset at the start of the next Refresh Interval.
The sum of the DL-PRBs allocated to all the UEs associated with a given MNO is determined every DL slot—DL-PRB_{MNO-x}=Σ_{MNO-x} DL-PRB_{MNO-x-UE}.
The sum of the UL-PRBs allocated to all the UEs associated with a given MNO is determined every UL slot—UL-PRB_{MNO-x}=Σ_{MNO-x} UL-PRB_{MNO-x-UE}.
The Refresh Internal starting slots are selected by spreading the UEs of a given MNO across slots and avoid having them all fall on the same slot.

Evolving the Scheduler Behavior Based on Real-Time Metrics

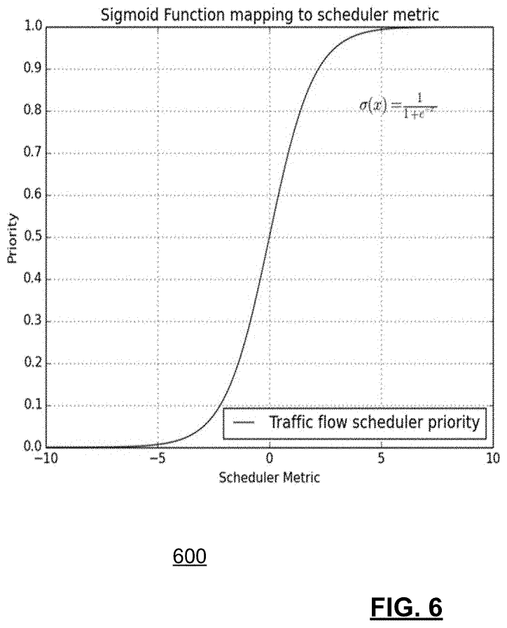

Use of sigmoid function for priority determination. FIG. 6 shows a plot of a Sigmoid Function Mapping to Scheduler Metric.

As the schedule is evolved, more metrics-based prioritization will be required. This process will take it beyond the approach of using the GBR/MBR/AMBR based scheduling.

When such an approach is utilized, normalization across different/independent metrics used for scheduling the different flows is required. The below Example Solution suggests the use a sigmoid function that is determined for each QoS flow type and the each metric assessed to determine of the SLO/SLA is met for the associated flow and the relative prioritization across UEs and across QoS flows that is used to determine the UEs/QoS flows that need to be scheduled.
The metrics used for prioritization are based on filtered values. The filter constants can be adjust based on the individual metric. Exponential filter should be sufficient.
For pdb=packet delay in the scheduler.
For GBR=R_avg−R_gbr
For nonGBR/BE=R_inst−R_avg−R_gbr; removing non-opportunistic traffic from the computation.
All priority computed in the range of [0, 1]=[low, high].
A higher computed metric will result in a value closer to 1.
As more resources are granted to the traffic-flow/UE, less likely it is to get more resources in the future.
Makes the behavior implicitly non-linear.
The steepness of the curve can be adjust based on the metric. This controls the aggressiveness of the throttling.

Allows for normalizing all scheduler metrics on a single scale.

### CONCLUSION

A Radio Access Network (RAN) Slice Scheduler methods and apparatus allowing shared resources from an Enterprise Network deployment to be managed across Mobile Network Operators (MNOs) and private Enterprise users is disclosed. Rebalancing of resource allocations provided to each MNO in the APs on a site is based on the population of User Equipment (UEs) and traffic experienced in accordance with the disclosed methods and apparatus.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A wireless communication network providing adaptive Mobile Network Operator (MNO) capacity limit, the network comprising:
a) A network resource management entity configured to:
i) determine whether there are not enough resources to admit an incoming GBR bearer of a given MNO and the MNO is using more than an allocated capacity; and
ii) not trigger preemption to admit new bearer.
